(19) United States
(12) Patent Application Publication
(10) Pub. No.: US 2022/0156760 A1
(43) Pub. Date: May 19, 2022

(54) CONFIGURING CHOICE COMPONENTS OF AN APPLICATION OR WEB PAGE USING A DATABASE SYSTEM

(71) Applicant: Salesforce.com, Inc., San Francisco, CA (US)

(72) Inventor: Brady SAMMONS, Walnut Creek, CA (US)

(73) Assignee: Salesforce.com, Inc., San Francisco, CA (US)

(21) Appl. No.: 17/099,428

(22) Filed: Nov. 16, 2020

(51) Int. Cl. G06Q 30/02; G06F 16/9538

(52) U.S. Cl. CPC G06Q 30/0201; G06F 16/9538

(57) ABSTRACT

A user interface may be caused to be displayed on a device of a user. The user interface may be configured to allow the user to create an application or web page. Instructions to configure a choice component of the application or web page may be received. The choice component may have a data source associated with one or more database objects of the database system and the choice component may have a display type defining how the choice component is displayable to users of the computing platform. The data source and the display type may be selectable by the user via the user interface. The choice component may be created or modified based on the instructions. The choice component may be published to a storage medium for transmission upon request to client devices accessing the application or web page.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever

### FIELD OF TECHNOLOGY

This patent document relates generally to configuring choice components of an application or web page and more specifically to configuring choice components of an application or web page using a database system.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks in association with production of applications and/or web pages.

### BRIEF DESCRIPTION OF THE DRAWINGS

The included drawings are for illustrative purposes and serve only to provide examples of possible structures and operations for the disclosed inventive systems, apparatus, methods and computer program products for configuring choice components of an application or web page. These drawings in no way limit any changes in form and detail that may be made by one skilled in the art without departing from the spirit and scope of the disclosed implementations.

FIG. 1 shows a flowchart of an example of a method for configuring choice components of an application or web page, in accordance with some implementations.

FIG. 2 shows a block diagram of an example of an application and/or web page configuration system, in accordance with some implementations.

FIG. 3 shows an example of a Graphical User Interface (GUI), in accordance with some implementations.

FIG. 4 shows an example of a GUI, in accordance with some implementations.

FIG. 5 shows an example of a GUI, in accordance with some implementations.

FIG. 6 shows an example of a GUI, in accordance with some implementations.

FIG. 7 shows an example of a GUI, in accordance with some implementations.

FIG. 8 shows an example of a GUI, in accordance with some implementations.

FIG. 9 shows an example of a GUI, in accordance with some implementations.

FIG. 10 shows a block diagram of an example of an environment that includes an on-demand database service configured in accordance with some implementations.

FIG. 11A shows a system diagram of an example of architectural components of an on-demand database service environment, configured in accordance with some implementations.

FIG. 11B shows a system diagram further illustrating an example of architectural components of an on-demand database service environment, in accordance with some implementations.

FIG. 12 illustrates one example of a computing device, in accordance with some implementations.

### DETAILED DESCRIPTION

Some implementations of the disclosed systems, apparatus, methods, and computer program products are configured for configuring (e.g., creating or modifying) choice components of an application or web page. The term “choice components,” as used herein describes, any component of any application or webpage that allows users to indicate a choice, e.g., picklists, multi-select picklists, radio buttons, checkboxes, etc. As described in further detail below, the disclosed techniques may be implemented alone or in association with any type of computing platform, such as a Customer Relationship Management (CRM) Platform, a social networking system, any type of consumer or business software, etc. While CRM platforms (such as those provided by salesforce.com®, inc.) are discussed herein as an example of such a computing platform, one having skill in the art can appreciate that the examples of computing platforms described herein may be substituted for any suitable computing platform, such as those described above.

Existing techniques for configuring choice components can be cumbersome, inflexible, and may require redundant work. By way of illustration, Isabella owns Measure for Measure Pizza, a small pizza chain that is in the process of creating a web page as well as a mobile application to be useable by customers to make online orders. Isabella is using a conventional CRM platform to aid in making the web page and mobile application. In the process of creating the web page and mobile application, Isabella wishes to create a number of choice components so that users of the web page and mobile application can choose between the many pizza toppings, crusts, specials, and other food offerings available at Measure for Measure Pizza. In order to configure choice components using these existing techniques, Isabella is faced with having to understand and define the data underlying each choice component (e.g., “resources”). In the conventional CRM platform, such resources are ill-defined, and unsupported resources are misleadingly presented. Additionally, the conventional CRM platform offers little guidance directing Isabella to resources she may want to leverage. Furthermore, the menu at Measure for Measure Pizza is seasonal and changes frequently. Using the conventional CRM platform, it is very difficult to change choice components once they are created. For instance, Isabella may wish to change the resource underlying a topping selection choice component from the August toppings menu to the September toppings menu. Unfortunately, this resource change alters the way the topping selection choice component is displayed, thereby causing the entire Measure for Measure Pizza menu to become unreadable to customers.

On the other hand, the disclosed techniques can be used to bifurcate choice component configuration into two separate and memorable processes, empowering users to handle data and display independently. By way of illustration, referring to the example described in the preceding paragraph, data binding may be handled in a wizard that informs the user as to what data type she may want to use as a “data source” for the choice component. Similarly, Isabella can seamlessly change the “display type” of the choice component (e.g., from a checkbox group to a multiselect picklist) simply by the click of a button, without affecting the “data source” and without the need to create additional choice components. As such, Isabella may easily change the data source of the topping selection choice component from the August toppings menu to the September toppings menu, without changing the way in which the topping selection choice component is displayed.

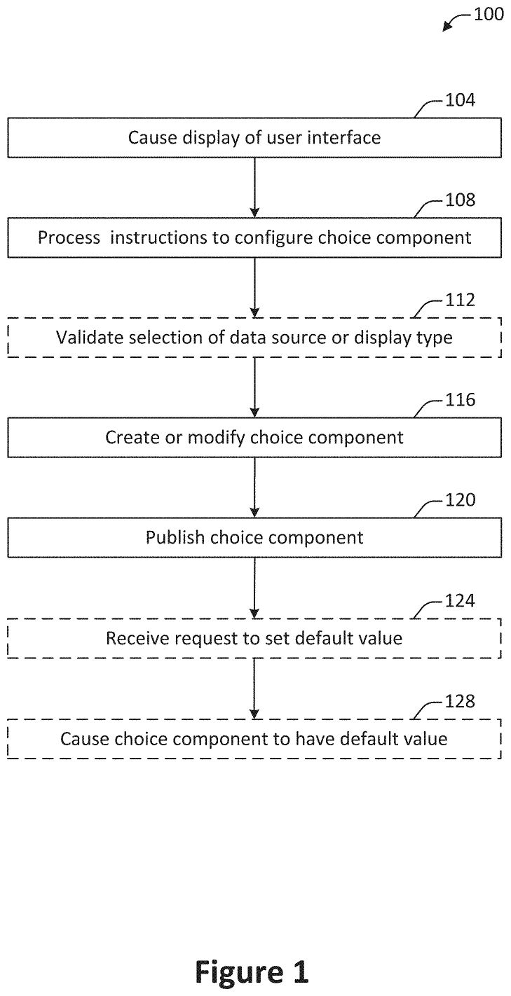

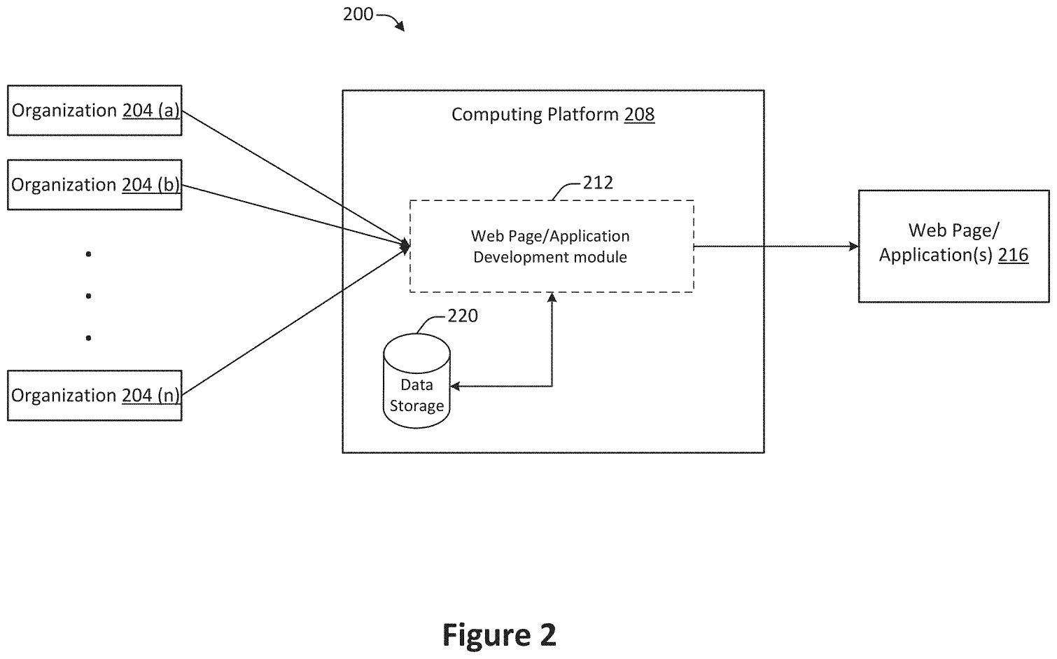

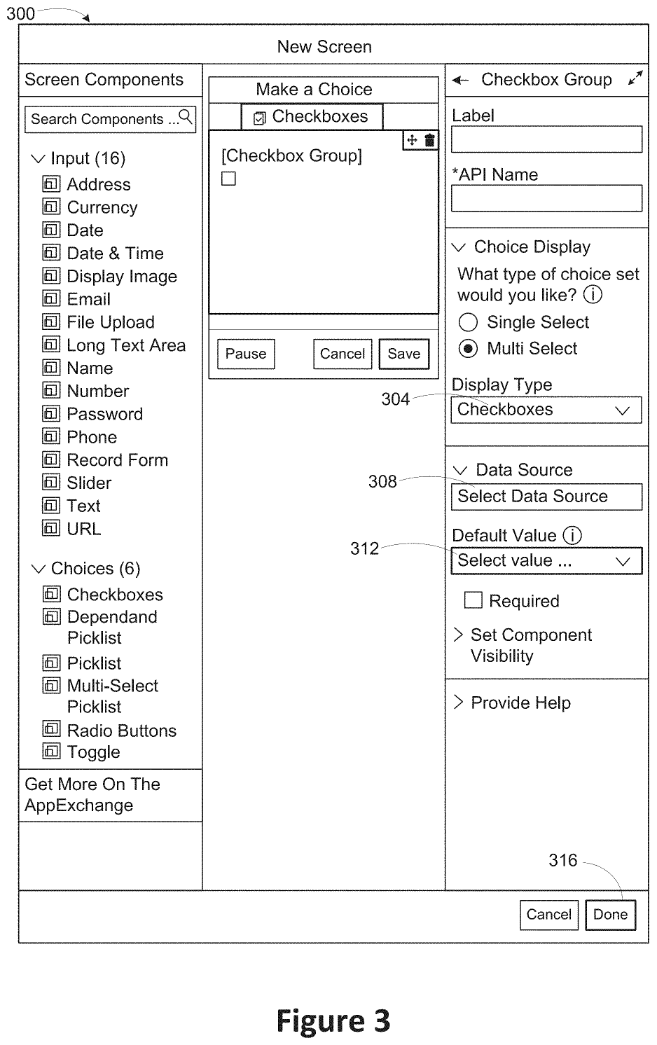

FIG. 1 shows a flowchart of an example of a method for configuring choice components of an application or web page, in accordance with some implementations. FIG. 1 is described in the context of FIGS. 2-9. FIG. 2 shows a block diagram of an example of an application and/or web page configuration system, in accordance with some implementations. FIGS. 3-9 show examples of Graphical User Interfaces (GUIs), in accordance with some implementations.

At 104 of FIG. 1, a user interface (UI) (e.g., UI 300 of FIG. 3) is caused to be displayed on a device of a user of a computing platform. The UI may be configured to allow the user to configure components (such as choice components) of an application or web page. By way of example, UI 300 may be displayed on Isabella's computer, and she may interact with the UI 300 to create components of an application or web page for Measure for Measure Pizza, as described below.

The computing platforms described herein may be implemented in a variety of manners. By way of example, in web page and/or application development environment 200 of FIG. 2, organizations 204 (a)-(n) interact with computing platform 208. As discussed above, the computing platform 208 may be any type of computing platform and may have a variety of components such as a CRM Platform, a social networking system, any type of consumer or business software, etc.

The computing platform 208 includes a web page and/or application development module 212, which may perform the web page and/or application configuration techniques disclosed herein. For instance, in some implementations, users affiliated with the organizations 204 (a)-(n) may request configuration of applications and/or web pages 216. The web page and/or application development module 212 may process such requests to generate such applications and/or web pages 216 component by component. By way of example, Measure for Measure Pizza may use a CRM platform, such as one provided by salesforce.com®, for configuration of their application and/or web page. The application and/or web page may be designable and/or customizable by authorized users affiliated with Measure for Measure Pizza. On behalf of Measure for Measure Pizza, Isabella may request configuration of the Measure for Measure Pizza web page. In response to Isabella's request, as discussed below, the web page and/or application development module 212 may access data stored in data storage 220 on behalf of the Measure for Measure Pizza organization. The web page and/or application development module 212 may use this information, as well as information entered by Isabella into UIs of the computing platform 208, to configure the Measure for Measure Pizza web page.

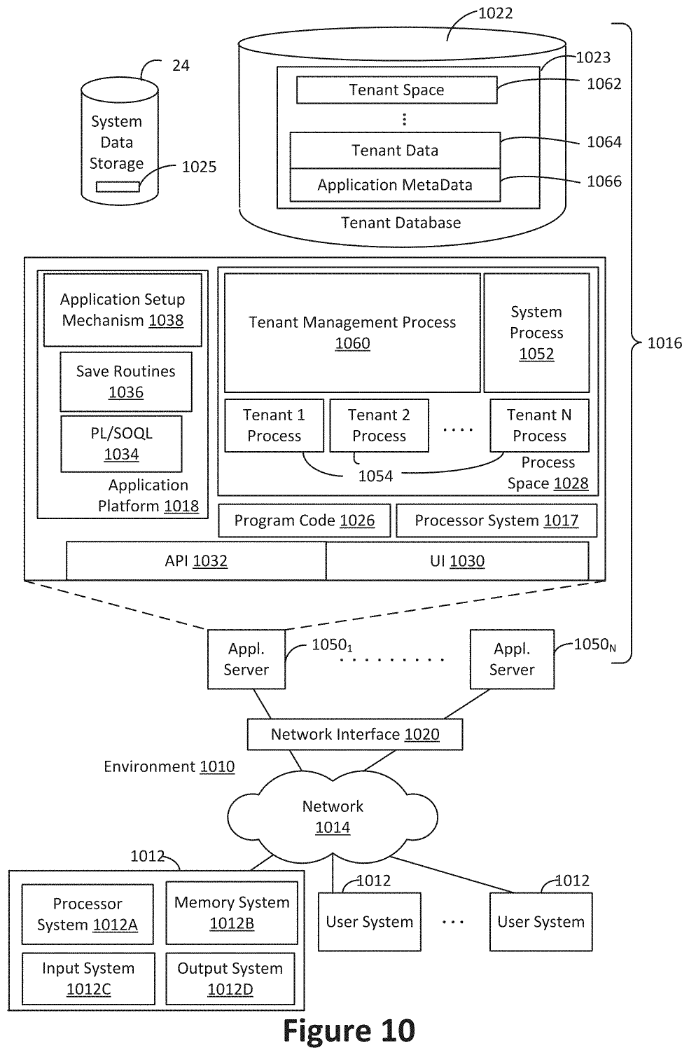

In some implementations, the computing platform 208 may be provided to the organizations 204 (a)-(n) via an on-demand computing environment, as discussed further below in the context of FIGS. 10-12. By way of example, the computing platform 208 may be provided to the organizations 204 (a)-(n) in a multi-tenant database system. Similar to tenant data storage 1022 of FIG. 10, data storage 220 of FIG. 2 may store data of the organizations 204 (a)-(n) in a multi-tenant architecture. The web page and/or application development module 212 may access the data storage 220 and use an organization's 204 (a)-(n) data when an application or web page is being configured, Similarly, the web page and/or application development module 212 may store metadata defining an organization's 204 (a)-(n) mobile application and/or web page in the data storage 220. Returning to the above example, the web page and/or application development module 212 may access Measure for Measure Pizza's data, which is stored in the data storage 220, when configuring the Measure for Measure Pizza web page. Once Isabella has provided information via UIs of the computing platform 208 to configure the Measure for Measure Pizza web page, the web page and/or application development module 212 may cause the information provided by Isabella to be stored in the data storage 220.

Returning to FIG. 1, at 108, instructions to configure a choice component of the application or web page are processed. By way of example, the instructions may be received at a server system associated with the computing platform 208 of FIG. 2. By way of illustration, returning to the above example, Isabella may be configuring the topping selection choice component using “Flow Builder” provided by salesforce.com®, inc. She may begin by dragging the desired choice component from a list of available screen components to the “canvas” (e.g., a working area configured to allow users to lay out components of an application or web page.) She may then configure the topping selection choice component using the techniques described below. As discussed above, the choice component may be a graphical component for indication of choices associated with the application or web page. The choice component may a data source associated with one or more database objects of a database system of the computing platform 208. The choice component may have a display type defining how the choice component may be displayable to users of the application or web page.

In some implementations, the display type may be selectable by a user via a UI. By way of illustration, Isabella may wish to choose the display type for the pizza topping selection choice component that she is creating for the Measure for Measure Pizza web page. Accordingly, Isabella may click or tap display type selection area 304 of FIG. 3. Isabella may then be presented with a list of potential display types (e.g., multi-select types such as a multi-select picklist or a checkbox group, single select types such as a radio button group, a single checkbox, etc.)

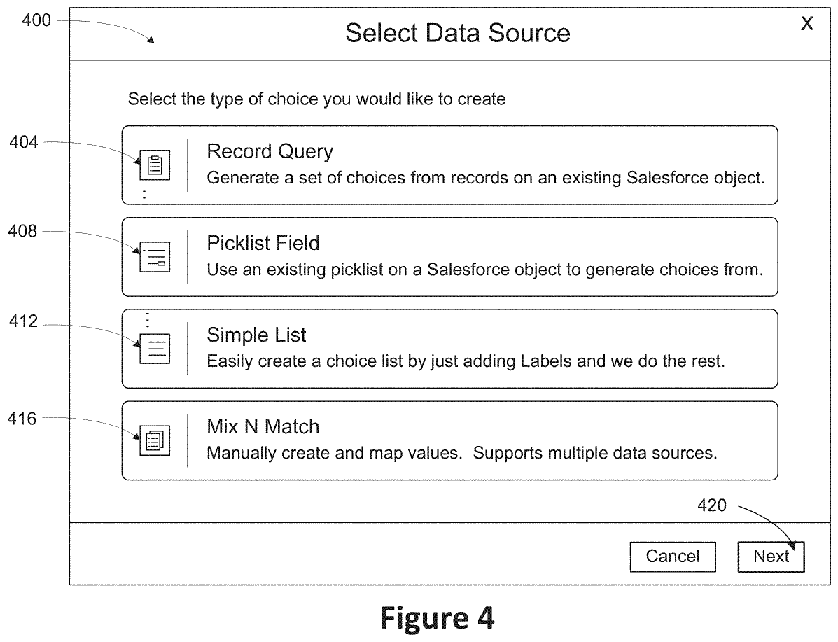

Also or alternatively, the data source may be selectable by a user via a UI. Isabella may wish to choose a data source for the pizza topping selection choice component that she is creating for the Measure for Measure Pizza web page. Accordingly, Isabella may click or tap data source selection area 308 of FIG. 3. After clicking or tapping the data source selection area 308, Isabella may be presented with data source selection screen 400 of FIG. 4. In the data source selection screen 400, Isabella may choose from a variety of data sources for the pizza topping selection choice component including a record query, a picklist field, a simple list, and a “mix n match” e.g., a combination of other data sources. Once Isabella has selected a data source, she may click or tap next button 420.

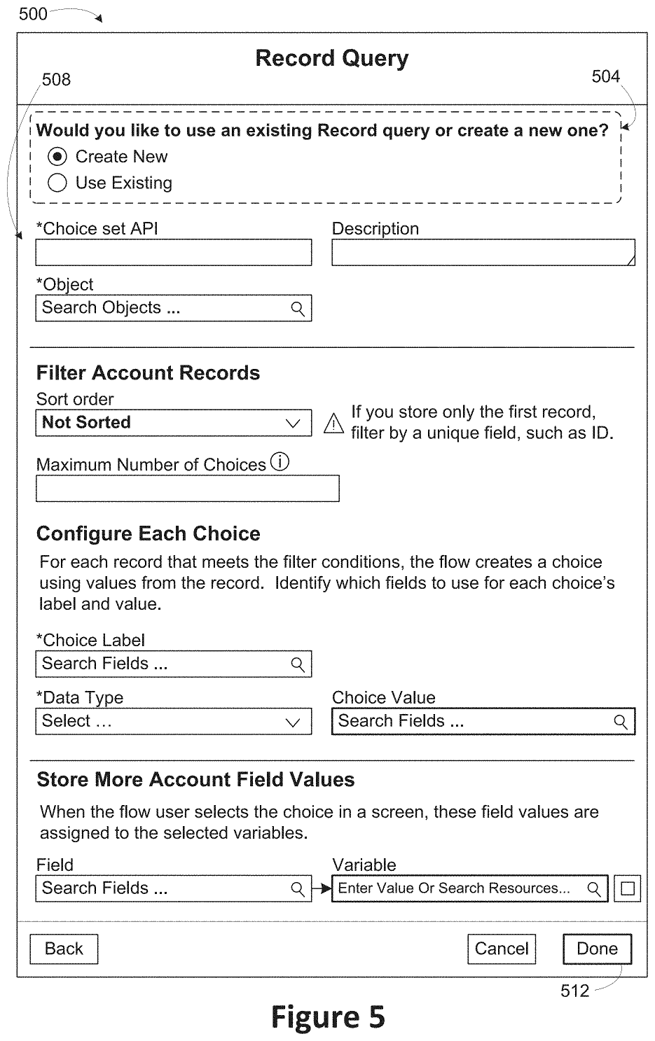

Such data sources may be selected and configured in a variety of manners. By way of example, Isabella may choose for the pizza topping selection choice component to have a record query data source. As such, she may click or tap record query selection 404 of FIG. 4. Upon selection of the record query selection 404, the computing platform 208 of FIG. 2 may cause record query configuration screen 500 of FIG. 5 to be displayed on Isabella's computing device. Isabella may then choose to create a new record query or use/modify an existing record query as the data source for the pizza topping selection choice component via selections 504. Isabella may then enter/modify defining characteristics (e.g., Application Program Interface (API) name, label, data type, etc.) of the data source for the pizza topping selection choice component in data source definition area 508. When Isabella is done defining the data source for the pizza topping selection choice component she may click or tap save button 512.

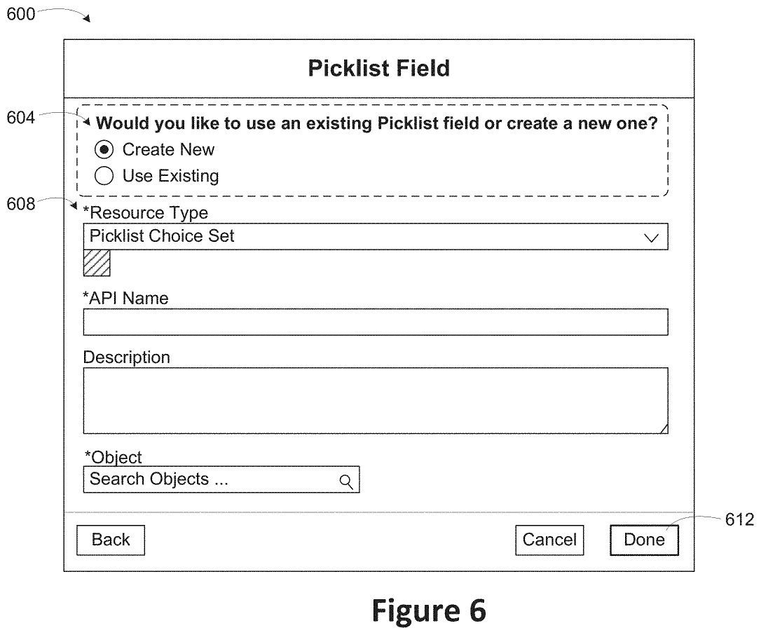

Also or alternatively, Isabella may choose for the pizza topping selection choice component to have a picklist field data source. As such, she may click or tap picklist field selection 408 of FIG. 4. Upon selection of the picklist field selection 408, the computing platform 208 of FIG. 2 may cause picklist field configuration screen 600 of FIG. 6 to be displayed on Isabella's computing device, Isabella may then choose to create a new picklist field or use/modify an existing picklist field as the data source for the pizza topping selection choice component via selections 604. Isabella may then enter/modify defining characteristics of the data source for the pizza topping selection choice component in data source definition area 608. When Isabella is done defining the data source for the pizza topping selection choice component she may click or tap done button 612.

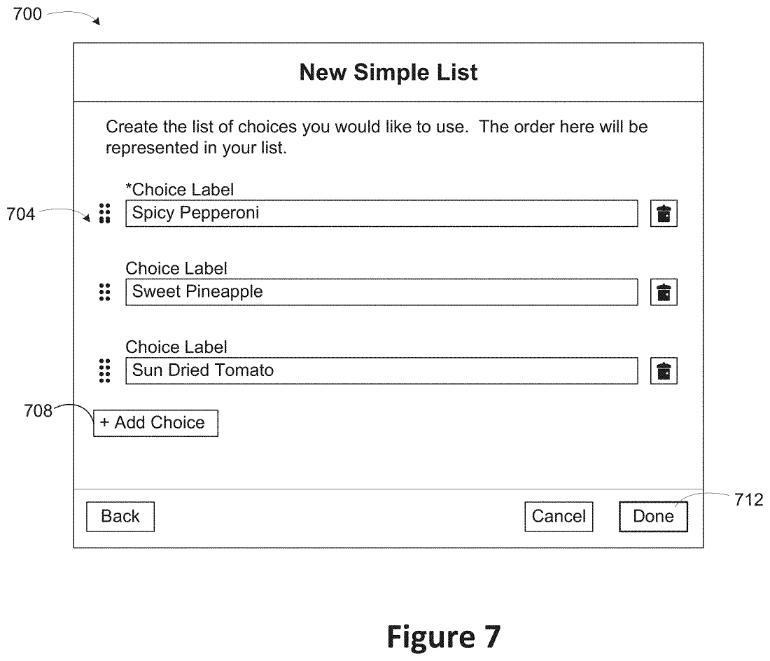

In some implementations, Isabella may choose for the pizza topping selection choice component to have a simple list data source. As such, she may click or tap simple list selection 412 of FIG. 4. Upon selection of the simple list selection 412, the computing platform 208 of FIG. 2 may cause simple list configuration screen 700 of FIG. 7 to be displayed on Isabella's computing device, Isabella may then enter/modify defining characteristics of each list entry in list entry definition area 704. Isabella may add new list entries by clicking or tapping add choice button 708. When Isabella is done defining the data source for the pizza topping selection choice component she may click or tap done button 712.

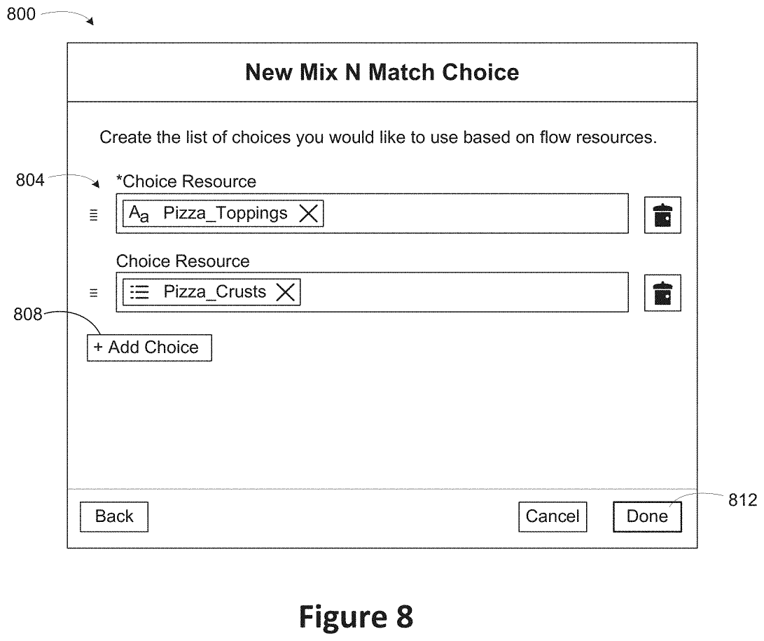

Also or alternatively, Isabella may choose to create a single choice component that includes both pizza toppings and pizza crusts. To do so, she may choose to use a mix n match data source. As such, she may click or tap mix n match selection 416 of FIG. 4. Upon selection of the mix n match selection 416, the computing platform 208 of FIG. 2 may cause mix n match configuration screen 800 of FIG. 8 to be displayed on Isabella's computing device. Isabella may then select resources underlying each list entry in resource definition area 804. For instance she may choose a first choice resource to include a list of available pizza toppings and she may choose a second choice resource to include a list of pizza crusts. Isabella may add new list entries by clicking or tapping add choice button 808. When Isabella is done defining the data source, she may click or tap done button 812.

In some implementations, selection of data source may be independent of selection of display type. As such, the display type may be configured to be modified independently of the data source. By way of illustration, Isabella may change the way in which the topping selection choice component is displayed without changing the data source from being the current seasonal toppings menu for Measure for Measure Pizza.

Also or alternatively, the data source may be configured to be modified independently of the display type. By way of example, Isabella may change the data source of the topping selection choice component from the Measure for Measure August toppings menu to the Measure for Measure September toppings menu without changing the way in which the topping selection choice component is displayed.

In some implementations, the disclosed techniques allow for automated validation preventing users from creating choice components that will not work. By way of illustration, returning to FIG. 1, in some implementations, at 112, selection of the data source and/or the display type may be automatically validated. For instance, when a user selects a particular data source and a particular display type for a choice component, the computing platform 208 of FIG. 2 may automatically check that the particular data source and the particular display type are compatible. By way of example, Isabella may select a single checkbox as the display type for the topping selection choice component, and she may select a simple list with more than one entry for the data source for the topping selection choice component. Since a single check box cannot visually represent a simple list with more than one entry, the computing platform 208 may automatically determine that Isabella's selection of display type and data source for the topping selection choice component is invalid. As such, Isabella may be presented with an error message explaining why her selection is invalid and instructing her to make a valid selection. On the other hand, if Isabella selects a display type and a data source that are compatible, the computing platform 208 may automatically determine that Isabella's selection is valid, and allow her to proceed with configuration of the choice component.

In some implementations, when Isabella has finished creating or modifying the topping selection choice component, she may click or tap “done” button 316 of FIG. 3.

At 116 of FIG. 1, the choice component may be created or modified via a processor based on the instructions processed at 108. By way of example, one or more processors of a server system of the computing platform 208 of FIG. 2 may create or modify the topping selection choice component based on Isabella's instructions in response to Isabella clicking or tapping the done button 316 of FIG. 3. The data underlying the topping selection choice component may then be stored in the data storage 220 of FIG. 2.

At 120 of FIG. 1, the choice component is published. According to various implementations, publishing the choice component may involve operations such as generating markup language code and/or computer programming language code for presenting the choice component in a web browser or application. In some implementations, the choice component may be published for presentation in more than one context, such as at a high resolution for presentation on a desktop or laptop screen and at a lower resolution for presentation on the screen of a smartphone.

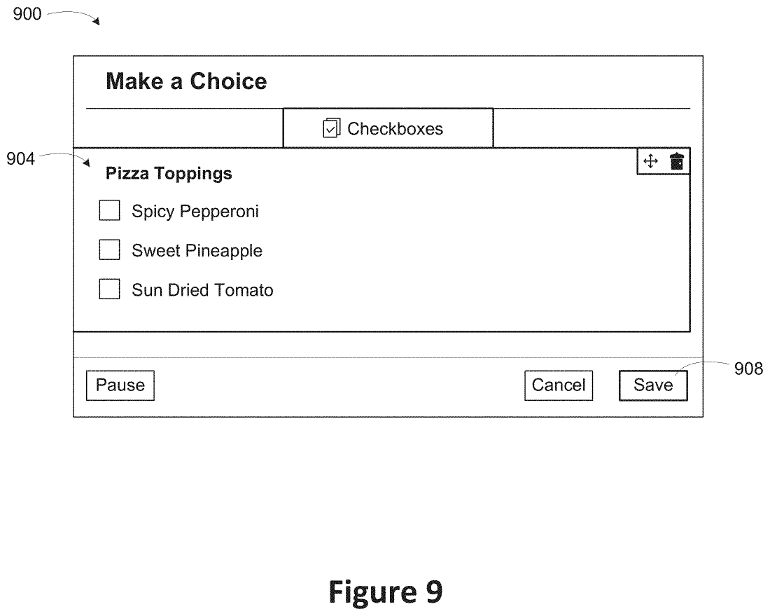

By way of example, the topping selection choice component may be published such that users of the Measure for Measure Pizza web page may be presented with topping selection choice component 900 of FIG. 9. When choosing toppings to order a pizza, a user may make selections in toppings selection area 904, and click or tap save button 908 when she has finished selecting toppings.

In some implementations, the disclosed techniques may allow for simple specification of default values for choice components. For instance, at 124 of FIG. 1 a request from a user to set a default value for a choice component may be received. By way of example, returning to FIG. 3, Isabella may click or tap default value selection 312 to choose a default value for the topping selection choice component. For example, Isabella may choose the default value to be the Measure for Measure Pizza daily special toppings.

In some implementations, at 128 of FIG. 1, a choice component may be caused to have the default value requested at 124. By way of example, a server system of the computing platform 208 of FIG. 2 may store data in the data storage 220, indicating that the default value of the topping selection choice component is the Measure for Measure Pizza daily special toppings. As such, whenever a user of the Measure for Measure Pizza web page first views the topping selection choice component, she will be presented with the default value of the Measure for Measure daily special toppings. She may then interact with the topping selection choice component if she wishes to order a pizza with toppings that are different from the daily special toppings. However, since the daily special is set as the default value of the topping selection choice component, users of the Measure for Measure Pizza web page can easily order a pizza with the daily special toppings without having to check any additional boxes in the topping selection choice component.

According to various embodiments, the method 100 may be performed while omitting one or more of the operations shown in FIG. 1. Alternately, or additionally, other operations may be performed in addition to those shown in FIG. 1.

In some implementations, operations shown in FIG. 1 may be performed in an order different than that shown. For example, sections and fields may be interchangeably added, deleted, ordered, and edited in any suitable order, for instance via a graphical user interface.

FIG. 10 shows a block diagram of an example of an environment 1010 that includes an on-demand database service configured in accordance with some implementations. Environment 1010 may include user systems 1012, network 1014, database system 1016, processor system 1017, application platform 1018, network interface 1020, tenant data storage 1022, tenant data 1023, system data storage 1024, system data 1025, program code 1026, process space 1028, User Interface (UI) 1030, Application Program Interface (API) 1032, PL/SOQL 1034, save routines 1036, application setup mechanism 1038, application servers 1050-1 through 1050-N, system process space 1052, tenant process spaces 1054, tenant management process space 1060, tenant storage space 1062, user storage 1064, and application metadata 1066. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality,

An on-demand database service, implemented using system 1016, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1018 may be a framework that allows the creation, management, and execution of applications in system 1016. Such applications may be developed by the database service provider or by users or third-party application developers accessing the service. Application platform 1018 includes an application setup mechanism 1038 that supports application developers' creation and management of applications, which may be saved as metadata into tenant data storage 1022 by save routines 1036 for execution by subscribers as one or more tenant process spaces 1054 managed by tenant management process 1060 for example. Invocations to such applications may be coded using PL/SOQL 1034 that provides a programming language style interface extension to API 1032. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1066 for a subscriber making such an invocation. Such system processes may also manage execution of application metadata 1066 as an application in a virtual machine.

In some implementations, each application server 1050 may handle requests for any user associated with any organization. A load balancing function (e.g., an F5 Big-IP load balancer) may distribute requests to the application servers 1050 based on an algorithm such as least-connections, round robin, observed response time, etc. Each application server 1050 may be configured to communicate with tenant data storage 1022 and the tenant data 1023 therein, and system data storage 1024 and the system data 1025 therein to serve requests of user systems 1012. The tenant data 1023 may be divided into individual tenant storage spaces 1062, which can be either a physical arrangement and/or a logical arrangement of data. Within each tenant storage space 1062, user storage 1064 and application metadata 1066 may be similarly allocated for each user. For example, a copy of a user's most recently used (MRU) items might be stored to user storage 1064, Similarly, a copy of MRU items for an entire tenant organization may be stored to tenant storage space 1062. A UI 1030 provides a user interface and an API 1032 provides an application programming interface to system 1016 resident processes to users and/or developers at user systems 1012.

System 1016 may implement a web-based application and/or web page configuration system. For example, in some implementations, system 1016 may include application servers configured to implement and execute a variety of software applications. The application servers may be configured to provide related data, code, forms, web pages and other information to and from user systems 1.012. Additionally, the application servers may be configured to store information to, and retrieve information from a database system. Such information may include related data, objects, and/or Web page content. With a multi-tenant system, data for multiple tenants may be stored in the same physical database object in tenant data storage 1022, however, tenant data may be arranged in the storage medium(s) of tenant data storage 1022 so that data of one tenant is kept logically separate from that of other tenants. In such a scheme, one tenant may not access another tenant's data, unless such data is expressly shared.

Several elements in the system shown in FIG. 10 include conventional, well-known elements that are explained only briefly here. For example, user system 1012 may include processor system 1012A, memory system 1012B, input system 1012C, and output system 1012D. A user system 1012 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1012 to access, process and view information, pages and applications available from system 1016 over network 1014. Network 1014 may be any network or combination of networks of devices that communicate with one another, such as any one or any combination of a LAN (local area network), WAN (wide area network), wireless network, or other appropriate configuration.

The users of user systems 1012 may differ in their respective capacities, and the capacity of a particular user system 1012 to access information may be determined at least in part by “permissions” of the particular user system 1012. As discussed herein, permissions generally govern access to computing resources such as data objects, components, and other entities of a computing system, such as an application and/or web page configuration system, a social networking system, and/or a CRM database system. “Permission sets” generally refer to groups of permissions that may be assigned to users of such a computing environment. For instance, the assignments of users and permission sets may be stored in one or more databases of System 1016. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices, This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1016 may provide on-demand database service to user systems 1012 using an MTS arrangement. By way of example, one tenant organization may be a company that employs a sales force where each salesperson uses system 1016 to manage their sales process. Thus, a user in such an organization may maintain contact data, leads data, customer follow-up data, performance data, goals and progress data, etc., all applicable to that user's personal sales process (e.g., in tenant data storage 1022). In this arrangement, a user may manage his or her sales efforts and cycles from a variety of devices, since relevant data and applications to interact with (e.g., access, view, modify, report, transmit, calculate, etc.) such data may be maintained and accessed by any user system 1012 having network access.

When implemented in an MTS arrangement, system 1016 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1016 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1016 may also maintain system-level data usable by multiple tenants or other data. Such system-level data may include industry reports, news, postings, and the like that are sharable between tenant organizations.

In some implementations, user systems 1012 may be client systems communicating with application servers 1050 to request and update system-level and tenant-level data from system 1016. By way of example, user systems 1012 may send one or more queries requesting data of a database maintained in tenant data storage 1022 and/or system data storage 1024. An application server 1050 of system 1016 may automatically generate one or more SQL statements (e.g., one or more SQL queries) that are designed to access the requested data. System data storage 1024 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

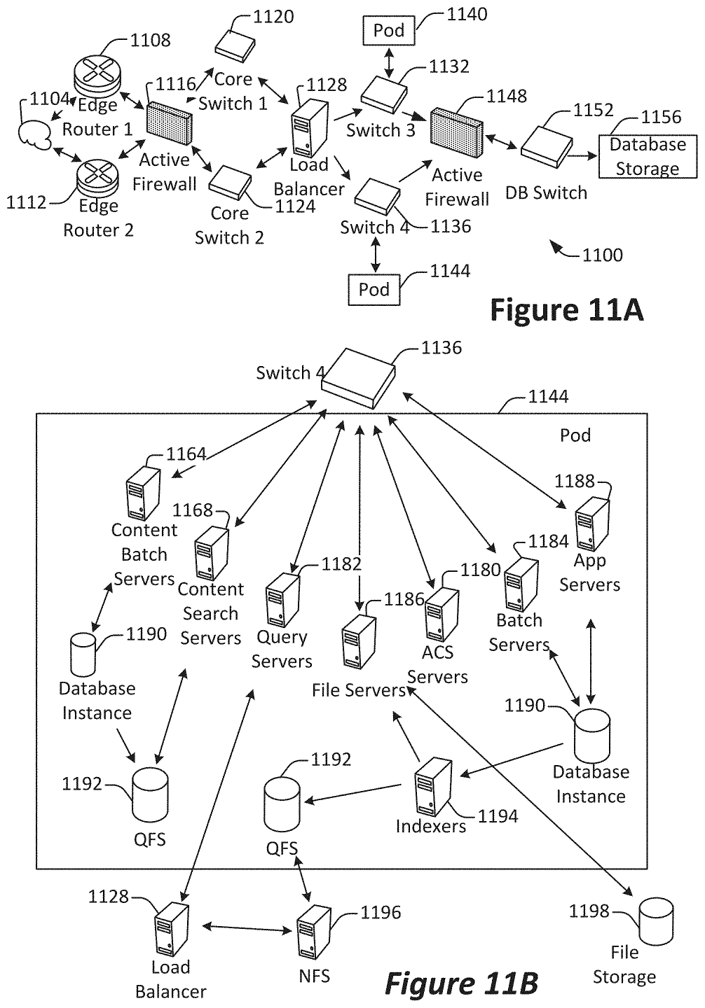

FIG. 11A shows a system diagram of an example of architectural components of an on-demand database service environment 1100, configured in accordance with some implementations. A client machine located in the cloud 1104 may communicate with the on-demand database service environment via one or more edge routers 1108 and 1112. A client machine may include any of the examples of user systems 1012 described above. The edge routers 1108 and 1112 may communicate with one or more core switches 1120 and 1124 via firewall 1116. The core switches may communicate with a load balancer 1128, which may distribute server load over different pods, such as the pods 1140 and 1144 by communication via pod switches 1132 and 1136. The pods 1140 and 1144, which may each include one or more servers and/or other computing resources, may perform data processing and other operations used to provide on-demand services. Components of the environment may communicate with a database storage 1156 via a database firewall 1148 and a database switch 1152.

Accessing an on-demand database service environment may involve communications transmitted among a variety of different components. The environment 1100 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 11A and 11B.

The cloud 1104 refers to any suitable data network or combination of data networks, which may include the Internet. Client machines located in the cloud 1104 may communicate with the on-demand database service environment 1100 to access services provided by the on-demand database service environment 1100. By way of example, client machines may access the on-demand database service environment 1100 to retrieve, store, edit, and/or process a variety of information.

In some implementations, the edge routers 1108 and 1112 route packets between the cloud 1104 and other components of the on-demand database service environment 1100. The edge routers 1108 and 1112 may employ the Border Gateway Protocol (BGP). The edge routers 1108 and 1112 may maintain a table of IP networks or ‘prefixes’, which designate network reachability among autonomous systems on the internet.

In one or more implementations, the firewall 1116 may protect the inner components of the environment 1100 from internet traffic. The firewall 1116 may block, permit, or deny access to the inner components of the on-demand database service environment 1100 based upon a set of rules and/or other criteria. The firewall 1116 may act as one or more of a packet filter, an application gateway, a stateful filter, a proxy server, or any other type of firewall.

In some implementations, the core switches 1120 and 1124 may be high-capacity switches that transfer packets within the environment 1100. The core switches 1120 and 1124 may be configured as network bridges that quickly route data between different components within the on-demand database service environment. The use of two or more core switches 1120 and 1124 may provide redundancy and/or reduced latency.

In some implementations, communication between the pods 1140 and 1144 may be conducted via the pod switches 1132 and 1136. The pod switches 1132 and 1136 may facilitate communication between the pods 1140 and 1144 and client machines, for example via core switches 1120 and 1124. Also or alternatively, the pod switches 1132 and 1136 may facilitate communication between the pods 1140 and 1144 and the database storage 1156. The load balancer 1128 may distribute workload between the pods, which may assist in improving the use of resources, increasing throughput, reducing response times, and/or reducing overhead. The load balancer 1128 may include multilayer switches to analyze and forward traffic.

In some implementations, access to the database storage 1156 may be guarded by a database firewall 1148, which may act as a computer application firewall operating at the database application layer of a protocol stack. The database firewall 1148 may protect the database storage 1156 from application attacks such as structure query language (SQL) injection, database rootkits, and unauthorized information disclosure. The database firewall 1148 may include a host using one or more forms of reverse proxy services to proxy traffic before passing it to a gateway router and/or may inspect the contents of database traffic and block certain content or database requests. The database firewall 1148 may work on the SQL application level atop the TCP/IP stack, managing applications' connection to the database or SQL management interfaces as well as intercepting and enforcing packets traveling to or from a database network or application interface.

In some implementations, the database storage 1156 may be an on-demand database system shared by many different organizations. The on-demand database service may employ a single-tenant approach, a mufti-tenant approach, a virtualized approach, or any other type of database approach. Communication with the database storage 1156 may be conducted via the database switch 1152. The database storage 1156 may include various software components for handling database queries. Accordingly, the database switch 1152 may direct database queries transmitted by other components of the environment (e.g., the pods 1140 and 1144) to the correct components within the database storage 1156.

FIG. 11B shows a system diagram further illustrating an example of architectural components of an on-demand database service environment, in accordance with some implementations. The pod 1144 may be used to render services to user(s) of the on-demand database service environment 1100. The pod 1144 may include one or more content batch servers 1164, content search servers 1168, query servers 1182, file servers 1186, access control system (ACS) servers 1180, batch servers 1184, and app servers 1188. Also, the pod 1144 may include database instances 1190, quick file systems (QFS) 1192, and indexers 1194. Some or all communication between the servers in the pod 1144 may be transmitted via the switch 1136.

In some implementations, the app servers 1188 may include a framework dedicated to the execution of procedures (e.g., programs, routines, scripts) for supporting the construction of applications provided by the on-demand database service environment 1100 via the pod 1144. One or more instances of the app server 1188 may be configured to execute all or a portion of the operations of the services described herein.

In some implementations, as discussed above, the pod 1144 may include one or more database instances 1190, A database instance 1190 may be configured as an MTS in which different organizations share access to the same database, using the techniques described above. Database information may be transmitted to the indexer 1194, which may provide an index of information available in the database 1190 to file servers 1186. The QFS 1192 or other suitable filesystem may serve as a rapid-access file system for storing and accessing information available within the pod 1144. The QFS 1192 may support volume management capabilities, allowing many disks to be grouped together into a file system. The QFS 1192 may communicate with the database instances 1190, content search servers 1168 and/or indexers 1194 to identify, retrieve, move, and/or update data stored in the network file systems (NFS) 1196 and/or other storage systems.

In some implementations, one or more query servers 1182 may communicate with the NFS 1196 to retrieve and/or update information stored outside of the pod 1144. The NFS 1196 may allow servers located in the pod 1144 to access information over a network in a manner similar to how local storage is accessed. Queries from the query servers 1122 may be transmitted to the NFS 1196 via the load balancer 1128, which may distribute resource requests over various resources available in the on-demand database service environment 1100. The NFS 1196 may also communicate with the QFS 1192 to update the information stored on the NFS 1196 and/or to provide information to the QFS 1192 for use by servers located within the pod 1144.

In some implementations, the content batch servers 1164 may handle requests internal to the pod 1144. These requests may be long-running and/or not tied to a particular customer, such as requests related to log mining, cleanup work, and maintenance tasks. The content search servers 1168 may provide query and indexer functions such as functions allowing users to search through content stored in the on-demand database service environment 1100. The file servers 1186 may manage requests for information stored in the file storage 1198, which may store information such as documents, images, basic large objects (BLOBs), etc. The query servers 1182 may be used to retrieve information from one or more file systems. For example, the query system 1182 may receive requests for information from the app servers 1188 and then transmit information queries to the NFS 1196 located outside the pod 1144. The ACS servers 1180 may control access to data, hardware resources, or software resources called upon to render services provided by the pod 1144. The batch servers 1184 may process batch jobs, which are used to run tasks at specified times. Thus, the batch servers 1184 may transmit instructions to other servers, such as the app servers 1188, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

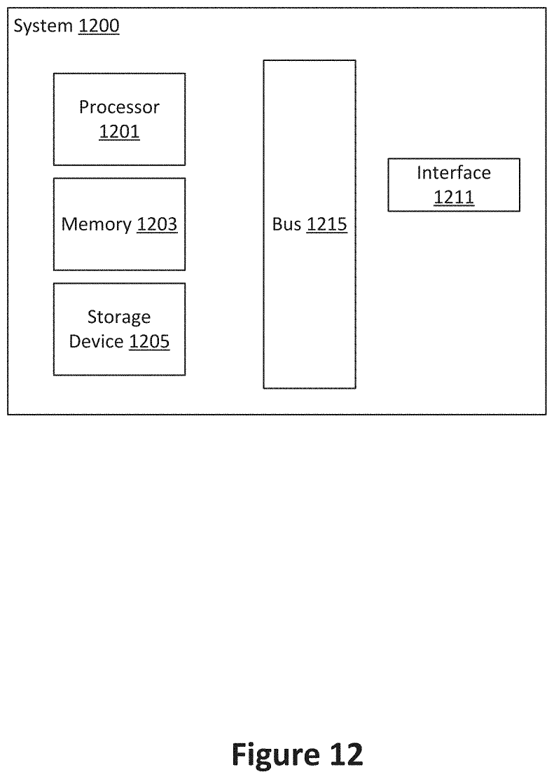

FIG. 12 illustrates one example of a computing device. According to various embodiments, a system 1200 suitable for implementing embodiments described herein includes a processor 1201, a memory module 1203, a storage device 1205, an interface 1211, and a bus 1215 (e.g., a PCI bus or other interconnection fabric.) System 1200 may operate as variety of devices such as an application server, a database server, or any other device or service described herein. Although a particular configuration is described, a variety of alternative configurations are possible. The processor 1201 may perform operations such as those described herein. Instructions for performing such operations may be embodied in the memory 1203, on one or more non-transitory computer readable media, or on some other storage device. Various specially configured devices can also be used in place of or in addition to the processor 1201. The interface 1211 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted, Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
causing display of, on a device of a user of a computing platform implemented via a database system, a user interface configured to allow the user to create an application or web page;
receiving, at a server system associated with the computing platform, instructions to configure a choice component of the application or web page, the choice component being a graphical component for indication of choices associated with the application or web page, the choice component having a data source associated with one or more database objects of the database system and the choice component having a display type defining how the choice component is displayable to users of the computing platform, the data source and the display type being selectable by the user via the user interface;
creating or modifying the choice component via a processor based on the instructions; and
publishing the choice component to a storage medium for transmission upon request to client devices accessing the application or web page.

2. The method of claim 1, wherein selection of the data source is independent of selection of the display type, the display type is configured to be modified independently of the data source, and the data source is configured to be modified independently of the display type.

3. The method of claim 1, the method further comprising:
automatically validating selection of the data source or the display type.

4. The method of claim 1, the method further comprising:
receiving a request from the user to set a default value for the choice component; and
causing the choice component to have the default value.

5. The method of claim 1, wherein the data source is one or more of: a record query, a picklist field, and/or a list.

6. The method of claim 1, wherein the display type is one or more of: a mufti-select picklist, a checkbox group, a radio button group, and/or a single checkbox.

7. The method of claim 1, wherein the computing platform comprises a customer relationship management (CRM) provided to a plurality of tenant organizations via an on-demand computing environment, the user being affiliated with a first one of the tenant organizations, the application or web page being associated with the first organization.

8. A computing system implemented by a server system, the computing system being configurable to cause:
causing display of, on a device of a user of a computing platform implemented via a database system, a user interface configured to allow the user to create an application or web page;
processing, at the server system associated, instructions to configure a choice component of the application or web page, the choice component being a graphical component for indication of choices associated with the application or web page, the choice component having a data source associated with one or more database objects of the database system and the choice component having a display type defining how the choice component is displayable to users of the computing platform, the data source and the display type being selectable by the user via the user interface;
creating or modifying the choice component via a processor based on the instructions; and
publishing the choice component to a storage medium for transmission upon request to client devices accessing the application or web page.

9. The computing system of claim 8, wherein selection of the data source is independent of selection of the display type, the display type is configured to be modified independently of the data source , and the data source is configured to be modified independently of the display type.

10. The computing system of claim 8, the computing system being further configurable to cause:
automatically validating selection of the data source or the display type.

11. The computing system of claim 8, the computing system being further configurable to cause:
processing a request from the user to set a default value for the choice component; and
causing the choice component to have the default value.

12. The computing system of claim 8, wherein the data source is one or more of: a record query, a picklist field, and/or a list.

13. The computing system of claim 8, wherein the display type is one or more of: a multi-select picklist, a checkbox group, a radio button group, and/or a single checkbox.

14. The computing system of claim 8, wherein the computing platform comprises a customer relationship management (CRM) provided to a plurality of tenant organizations via an on-demand computing environment, the user being affiliated with a first one of the tenant organizations, the application or web page being associated with the first organization.

15. A computer program product comprising computer-readable program code capable of being executed by one or more processors when retrieved from a non-transitory computer-readable medium, the program code comprising instructions configurable to cause: causing display of, on a device of a user of a computing platform implemented via a database system, a user interface configured to allow the user to create an application or web page;
processing, at a server system associated with the computing platform, instructions to configure a choice component of the application or web page, the choice component being a graphical component for indication of choices associated with the application or web page, the choice component having a data source associated with one or more database objects of the database system and the choice component having a display type defining how the choice component is displayable to users of the computing platform, the data source and the display type being selectable by the user via the user interface;
creating or modifying the choice component based on the instructions; and
publishing the choice component to a storage medium for transmission upon request to client devices accessing the application or web page.

16. The computer program product of claim 15, wherein selection of the data source is independent of selection of the display type, the display type is configured to be modified independently of the data source , and the data source is configured to be modified independently of the display type.

17. The computer program product of claim 15, the instructions being further configurable to cause:
automatically validating selection of the data source or the display type.

18. The computer program product of claim 15, the instructions being further configurable to cause:
processing a request from the user to set a default value for the choice component; and
causing the choice component to have the default value.

19. The computer program product of claim 15, wherein the data source is one or more of: a record query, a picklist field, and/or a list.

20. The computer program product of claim 15, wherein the display type is one or more of: a multi-select picklist, a checkbox group, a radio button group, and/or a single checkbox.
